(19) United States
(12) Patent Application Publication
(10) Pub. No.: US 2014/0279348 A1
(43) Pub. Date: Sep. 18, 2014

(54) TRADING INTERFACE FOR SINGLE-CLICK OPEN ORDER CANCEL-REPLACE

(71) Applicant: TD AMERITRADE IP COMPANY, INC., Omaha, NE (US)

(72) Inventors: John D. PETERSEN, Jersey City, NJ (US); Bryan E. SAMPIERI, Jersey City, NJ (US); Victor A. JONES, Chicago, IL (US)

(73) Assignee: TD AMERITRADE IP COMPANY, INC., Omaha, NE (US)

(21) Appl. No.: 13/840,184

(22) Filed: Mar. 15, 2013

(51) Int. Cl. G06Q 40/04

(52) U.S. Cl. CPC G06Q 40/04
USPC 705/37

(57) ABSTRACT

Methods, systems, and apparatuses, including computer programs encoded on computer-readable media, for requesting one or more open orders from a trading platform and sending to a client. Price data for at least one of the one or more orders is requested and sent to the client. A limit price for a first open order from the one or more open orders is received and a new order request is built. The order request is based at least on the first open order and the limit price. A cancel order request is built based at least on the first open order. A cancel-replace request is send to the trading platform. The cancel-replace request is based at least on the new order request and the cancel order request. The trading platform cancels an open order and opens a new order based on the cancel-replace request.

### BACKGROUND

Online trading applications allow users to buy and sell securities, such as stocks or options, using a computing device. There are various implementations that can give users access to trading platforms. FIG. 1 illustrates a block diagram of a system. A user can access a web server 104 by using a client 102. The web server 104 can access a trading platform 106. The web server 104 can receive requests from the client 102 and send content to the client 102. Additionally, a trading platform 106 can be accessed by the web server 104. The web server 104 can retrieve information from the trading platform 104 and can also submit information to the trading platform 106. For example, the web server 104 can retrieve open orders for a user from the trading platform 106 and send the open orders to a client 102. Additionally, the web server 104 can receive a purchase request from the client 102, build an order for the purchase request, and submit an instruction to the trading platform 106.

Instructions sent to a trading platform can include orders, such as an order for a purchase request. Each purchase order can identify a security, the quantity that a user wishes to purchase of the security, and the price at which the user wishes to purchase. In some cases, an existing order may need to be updated. For example, a user can submit a purchase order for a security with a specified quantity and a specified limit price. The trading platform can fill the order by purchasing the specified security at a price at or below the limit price. If, however, the security is performing over the limit price, then the trading platform cannot fill the purchase order at or below the limit price. In such a case, the user can determine that the limit price associated with an order should be changed. Existing systems require users to cancel an existing order and then create a new order with the updated data. Because users are required to first cancel an existing order and then submit a new order, the process of updating an order can be cumbersome and inefficient in fast moving markets.

### SUMMARY

In general, one aspect of the subject matter described in this specification can be embodied in methods for receiving a new limit price for an open order and sending a cancel-replace request to a trading platform. One or more open orders are requested from a trading platform. The one or more open orders are sent to a client. Price data for at least one of the one or more orders is requested. The requested data is sent to the client. A limit price for a first open order from the one or more open orders is received. A new order request is built. The order request is based at least on the first open order and the limit price. A cancel order request is built. The cancel order request is based at least on the first open order. A cancel-replace request is send to the trading platform. The cancel-replace request is based at least on the new order request and the cancel order request. The trading platform cancels and open order based on the cancel-replace request and opens a new order based on the cancel-replace request. Other implementations of this aspect include corresponding systems, apparatuses, and computer-readable media configured to perform the actions of the method.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 is a block diagram of a system in accordance with an illustrative implementation.

FIG. 2 is an illustration of a trading interface based upon an open order in accordance with an illustrative implementation.

FIG. 3 is a flow diagram of a process for building a cancel-replace order in accordance with an illustrative implementation.

FIG. 4 is a block diagram of a computer system in accordance with an illustrative implementation.

Like reference numbers and designations in the various drawings indicate like elements.

### DETAILED DESCRIPTION

The implementations that follow are aimed at improving the efficiency of updating information related to an open order. The various implementations can be used with various online trading platforms. In one implementation, a user can modify an open order on a client 102. For example, if an open order is not filling because the limit price is set too low, the user can set a new limit price. A web server 104 can receive the order update request from the client 102. Upon receipt of the order update request, the web server 104 can submit a cancel request for the open order and a new order request with the new limit price to the trading platform 106. For example, the web server 104 can receive a new limit price for an open order. The limit price determines the maximum amount that a user is willing to pay on a per share basis to fulfill an order. The web server 104 can determine that the limit price is different from the limit price in the open order and, if the two prices are different, the web server 104 can create one or more instructions directed at the trading platform 106, such that the open order is canceled and a new order is submitted with the new limit price for the same quantity of shares that were outstanding in the open order. In one example, the cancel request and the new order request can be sent using a single cancel-replace request to the trading platform. In another example, the cancel request and the new order request can be sent as separate requests to the trading platform 106. In one embodiment, the client is provided an indication of the quantity of the security, such as number of shares, that were purchased through the open order prior to the cancel-replace request.

FIG. 2 is an illustration of a user interface retrieved based upon an open order in accordance with an illustrative implementation. A client 102 can display a user interface 202 upon selection, by a user, of an open order in the trading interface (not shown). In an implementation, the user interface 202 can include information related to the open order. For example, the user interface 202 can include an open order identifier 204 uniquely associated with the open order and the security identifier 206 for the security associated with the open order. The security associated with the open order can be any security, including, but not limited to, a stock or an option. The user interface can also present additional data, such as price data for the security identified by the security identifier 206. For example, the user interface 202 can include buttons or links for the current bid price 208, the current ask price 210, the last price 212, and the mark price 214, for the security associated with the open order identifier 204. In an implementation, the user interface 202 can be updated each time information related to the open order is changed. Therefore, if the current ask price button 210 displays a dollar amount indicating the current ask price, the dollar amount displayed on the current ask price button 210 can be updated each time new current ask price data is available. The user can select one of the listed prices as the new limit price. For example, the user can select the current ask price by clicking on the current ask price button 210. The price displayed by the button can be sent to the web server 104 as the new limit price for the open order associated with the open order identifier 204.

FIG. 3 is a flow diagram of a process for building a cancel-replace order in accordance with an illustrative implementation. The process 300 can be implemented on a computing device. In one implementation, the process 300 is encoded on a computer-readable medium that contains instructions that, when executed by a computing device, cause the computing device to perform operations of process 300.

The web server 104 can request open orders from a trading platform (302). In an implementation, a web server 104 can receive a request from a client 102 for open orders associated with a user accessing the client 102. For example, a user can navigate to a portion of the trading interface on which all open orders are displayed. The web server 104 can initiate a request directed to a trading platform 106 for open orders associated with the user. An open order can be any order that has not been executed at the time of the request. The request sent to the trading platform 106 can be formatted in any number of ways. For example, the request can be formatted as XML data, wherein the XML data identifies the user and the type of orders to be retrieved (e.g., open orders).

The web server 104 can receive open orders from a trading platform (304). In an implementation, the web server 104 can receive, for example, a data file containing all open orders matching the request sent in operation 302. The received data can be processed to extract the open orders. The web server 104 can add or remove additional data from the received open orders (not shown). For example, the open orders received from the trading platform 106 can include a security symbol. The web server 104 can optionally retrieve the full corporate name associated with the security symbol from another source and add that name to the open order before sending the open order to the client 102.

The web server 104 can send the open orders to a client (306). In an implementation, the web server 104 can determine which of the open orders received from the trading platform 106 can be sent to the client. For example, the web server 104 can limit the number of orders displayed at a given time to a predetermined number, such as, but not limited to, 3, 5, 10. etc. For example, if the web server 104 receives 30 open orders, the web server 104 can send just the first 10 to the client. In another example, the client 102 can request open orders beginning at a pre-determined offset. Thus, if the client requests open orders starting at the eleventh open order, the web server 104 can send open orders 11-20 from the list above. In another implementation, the web server 104 can filter the open orders returned from the trading platform 106 based on characteristics such as, but not limited to, how long the order has been open, the closing date, etc. The web server 104 can filter based on how long the orders have been open and send only the open orders that have been open for at least a predetermined amount of time, such as twenty-four hours.

For each open order sent to the client 102, the web server 104 can request price data for the security associated with the open order (308). In an implementation, the web server 104 can retrieve different prices for the security associated with the open order. For example, the web server 104 can request the current bid price, the current ask price, the last price, and the mark price associated with the security in the order. Each price indicates a different valuation of the security.

The web server 104 can send price data to the client (310). In an implementation, the price data can be formatted as, but not limited to, a series of buttons, links or keyboard shortcuts, such as buttons 208, 210, 212, 214, as depicted in FIG. 2. The web server 104 can periodically request price data for the security associated with the open order (308) and send the price data to the client (310) while waiting for the client 102 to send a new limit price. In another example, the price data for the security can be received in real time and can also be sent to the client 102 in real time. Thus, the client will receive updated pricing for the security each time new security pricing is available. For example, the current ask price for a security can be $10.00. The client can display the current ask price as the current ask price button 210, referring to FIG. 2. If the web server 104 retrieves the current ask price for the same security at a later time and determines that the updated current ask price is $10.01, the updated price can be sent to the client 102. Upon receiving the updated current ask price, the client can update the current ask price button 210 to display the new current ask price of $10.01. Additionally, if a user clicks on the current ask price button 210 after the button has been updated, then the new limit price sent to the server will be $10.01. In an implementation, referring to FIG. 2, the user accessing the client 102 can select a new limit price by selecting one of the displayed prices by a single action, such as, but not limited, clicking on a button, clicking on a link, pushing a keyboard shortcut, etc. For example, the user can select one of the price buttons 208, 210, 212, 214 to indicate a new limit price for the open order associated with the open order identifier 204. Thus, the user can select the current ask price 210, which displays a price of $10.01, as the new limit price. The client 102 can send a request to the web server 104 that includes the limit price of $10.01 and the open order identifier 204 of the open order.

Once the user selects a price button, the web server 104 can receive the new limit price from the client (312). Upon receiving the new limit price, the web server 104 can determine if a cancel-replace request should be sent to the trading platform 106. For example, the web server 104 can compare the limit price of the open order and the new limit price. If the two prices are the same, then the web server 104 can ignore the request. If, however, the two prices are not the same, then the web server 104 can build a cancel-replace request, as described below. In another implementation, the web server 104 can receive the new limit price and build a cancel-replace request, as described below, and send the cancel-replace request to the trading platform 106. Thus, the trading platform 106 can determine whether the cancel-replace request should be accepted. For example, the trading platform 106 can determine that the new limit price in the cancel-build request and the old limit price in the open order are identical. Because the cancel-build request, if executed, will create a new order with the same limit price as the existing order, the trading platform can reject the cancel-build request. Thus, no action will be taken on the open order in such a case.

The web server 104 can build a cancel-replace request with the received limit price (316). In an implementation, the web server 104 can build a new order request. The new order can include the security identifier 206 of the open order, the quantity of the open order, and the new limit price received from the client 102. Additionally, the web server 104 can build a cancel order request. The cancel order request can, for example, include the open order identifier.

The web server 104 can send the cancel order request and the new order request to the trading platform 106 (318). In an implementation, the cancel order request and the new order request can be sent as a single cancel-replace request to the trading platform. Thus, the web server 104 can receive a single instruction from the client 102 to adjust the limit price for an open order and can cancel the open order and request a new order with the new limit price with a single request to the trading platform 106. In another implementation, the web server 104 can first send the cancel request and then send the new order request. The cancel-replace request can be created to modify multiple aspects of an open order including, but not limited to, the limit price, the quantity of shares, the closing date of the order, etc.

FIG. 4 is a block diagram of a computer system in accordance with an illustrative implementation. The computer system or computing device 400 can be used to implement cell phones, clients, servers, cloud computing resources, etc. The computing system 400 includes a bus 405 or other communication component for communicating information and a processor 410 or processing circuit coupled to the bus 405 for processing information. The computing system 400 can also include one or more processors 410 or processing circuits coupled to the bus for processing information. The computing system 400 also includes main memory 415, such as a random access memory (RAM) or other dynamic storage device, coupled to the bus 405 for storing information, and instructions to be executed by the processor 410. Main memory 415 can also be used for storing position information, temporary variables, or other intermediate information during execution of instructions by the processor 410. The computing system 400 may further include a read only memory (ROM) 410 or other static storage device coupled to the bus 405 for storing static information and instructions for the processor 410. A storage device 425, such as a solid state device, magnetic disk or optical disk, is coupled to the bus 405 for persistently storing information and instructions.

The computing system 400 may be coupled via the bus 405 to a display 435. An input device 430, such as a keyboard, may be coupled to the bus 405 for communicating information and command selections to the processor 410. In another implementation, the input device 430 has a touch screen display 435. The input device 430 can include a cursor control, such as a mouse, a trackball, or cursor direction keys, for communicating direction information and command selections to the processor 410 and for controlling cursor movement on the display 435.

According to various implementations, the processes described herein can be implemented by the computing system 400 in response to the processor 410 executing an arrangement of instructions contained in main memory 415. Such instructions can be read into main memory 415 from another computer-readable medium, such as the storage device 425. Execution of the arrangement of instructions contained in main memory 415 causes the computing system 400 to perform the illustrative processes described herein. One or more processors in a multi-processing arrangement may also be employed to execute the instructions contained in main memory 415.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Moreover, the separation of various system components in the implementations described above should not be understood as requiring such separation in all implementations, and it should be understood that the described program components and systems can generally be integrated in a single software product or packaged into multiple software products.

Similarly, while operations are depicted in the drawings in a particular order, this should not be understood as requiring that such operations be performed in the particular order shown or in sequential order, or that all illustrated operations be performed, to achieve desirable results. Thus, particular implementations of the subject matter have been described. Other implementations are within the scope of the following claims.

What is claimed is:

1. A method comprising:
requesting, using a processor, one or more open orders from a trading platform;
sending at least one of the one or more open orders to a client;
requesting price data for the at least one of the one or more open orders;
sending the price data to the client;
receiving a limit price for a first open order from the one or more open orders;
building a new order request, wherein the new order request is based at least on the first open order and the limit price;
building a cancel order request, wherein the cancel order request is based at least on the first open order; and
sending a cancel-replace request to the trading platform, wherein the cancel-replace request is based at least on the new order request and the cancel order request, wherein the trading platform cancels an open order based on the cancel-replace request and opens a new order based on the cancel-replace request.

2. The method of claim 1, further comprising:
determining that a limit price has not been received for the at least one of the one or more open orders;
requesting updated price data for the at least one of the one or more open orders; and
sending the updated price data to the client2

3. The method of claim 1, wherein the price data is based on market prices for the at least one of the one or more open orders.

4. The method of claim 3, wherein the price data comprises at least one of a current bid price, a current asking price, a last price, and a mark price.

5. The method of claim 1, further comprising requesting open orders corresponding to a predetermined timeframe and wherein the one or more open orders have been open for at least the predetermined timeframe.

6. The method of claim 1, wherein the open order is for the purchase of one or more shares of a stock.

7. The method of claim 1, wherein the open order is for the purchase of one or more options.

8. The method of claim 1, wherein the client generates a user interface based on the price data, wherein the user interface comprises one or more indications of an action, and wherein the limit price is selected using the generated user interface, wherein selecting one of the one or more indications of an action using the generated user interface selects the limit price.

9. A system comprising:
one or more processors configured to:
request one or more open orders from a trading platform;
send at least one of the one or more open orders to a client;
request price data for the at least one of the one or more open orders;
send the price data to the client;
receive a limit price for a first open order from the one or more open orders;
build a new order request, wherein the new order request is based at least on the first open order and the limit price;
build a cancel order request, wherein the cancel order request is based at least on the first open order; and
send a cancel-replace request to the trading platform, wherein the cancel-replace request is based at least on the new order request and the cancel order request, wherein the trading platform cancels the first open order based on the cancel-replace request and opens a new order based on the cancel-replace request.

10. The system of claim 9, wherein the one or more processors are further configured to:
determine that a limit price has not been received for the at least one of the one or more open orders;
request updated price data for the at least one of the one or more open orders, wherein limit price data has not been received for the at least one of the one or more open orders; and
send the updated price data to the client.

11. The system of claim 9, wherein the price data is based on market prices for the at least one of the one or more open orders.

12. The system of claim 11, wherein the price data comprises at least one of a current bid price, a current asking price, a last price, and a mark price.

13. The system of claim 9, wherein the one or more processors are further configured to request open orders corresponding to a predetermined timeframe and wherein the one or more open orders have been open for at least the predetermined timeframe.

14. The system of claim 9, wherein the open order is for the purchase of one or more shares of a stock.

15. The system of claim 9, wherein the open order is for the purchase of one or more options.

16. The system of claim 9, wherein the client generates a user interface based on the price data, wherein the user interface comprises one or more indications of an action, and wherein the limit price is selected using the generated user interface, wherein selecting one of the one or more indications of an action using the generated user interface selects the limit price.

17. A non-transitory computer-readable medium having instructions stored thereon, wherein the instructions comprise:
instructions for requesting one or more open orders from a trading platform;
instructions for sending at least one of the one or more open orders to a client;
instructions for requesting price data for the at least one of the one or more open orders;
instructions for sending the price data to the client;
instructions for receiving a limit price for a first open order from the one or more open orders;
instructions for building a new order request, wherein the new order request is based at least on the first open order and the limit price;
instructions for building a cancel order request, wherein the cancel order request is based at least on the first open order; and
instructions for sending a cancel-replace request to the trading platform, wherein the cancel-replace request is based at least on the new order request and the cancel order request, wherein the trading platform cancels an open order based on the cancel-replace request and opens a new order based on the cancel-replace request.

18. The non-transitory computer-readable medium of claim 17, wherein the instructions further comprise:
instructions for determining that a limit price has not been received for the at least one of the one or more open orders;
instructions for requesting updated price data for the at least one of the one or more open orders, wherein limit price data has not been received for the at least one of the one or more open orders; and
instructions for sending the updated price data to the client.

19. The non-transitory computer-readable medium of claim 17, wherein the price data is based market prices for the one of the one or more open orders.

20. The non-transitory computer-readable medium of claim 19, wherein the price data comprises at least one of a current bid price, a current asking price, a last price, and a mark price.
